(19) United States
(12) Patent Application Publication
(10) Pub. No.: US 2018/0113842 A1
(43) Pub. Date: Apr. 26, 2018

(54) OBJECTIVE-BASED RENDERING OF CONTENT ITEMS

(71) Applicant: LinkedIn Corporation, Mountain View, CA (US)

(72) Inventors: Jie Xiao, Sunnyvale, CA (US); Yawen Wei, Sunnyvale, CA (US); Divye Khilnani, Sunnyvale, CA (US); Eva Chau, Mountain View, CA (US)

(21) Appl. No.: 15/334,149

(22) Filed: Oct. 25, 2016

(51) Int. Cl. G06F 17/21; G06F 17/22; H04L 29/06; G06F 17/30

(52) U.S. Cl. CPC G06F 17/211; G06F 17/2235; H04L 67/02; H04L 65/601; G06F 17/3089; G06F 17/2247

(57) ABSTRACT

Techniques for selectively generating and rendering content items are provided. A content request that includes an identifier is received over a network. In response to receiving the content request, an entity profile of an entity that is associated with the identifier is retrieved. A content item is identified based on the entity profile. Based on a content item identifier that identifies the content item, a particular campaign objective from among a plurality of campaign objectives is determined. A particular format for, or particular content to include with, the content item is determined based on the particular campaign objective. A rendered content item is generated based on the content item and at least one of the particular format and the particular content and the rendered content item is displayed on a screen of a computing device.

### TECHNICAL FIELD

The present disclosure relates to rendering content items based on objectives associated with content delivery campaigns.

### BACKGROUND

Web pages can display content items, which can include images, video, audio, text, graphics, virtual reality, or any combination thereof. Content items are generated by programs in response to requests and are composed of individual “elements” (e.g., an individual image, text sample, etc.). In some cases, content and/or format of content items are determined by visitors of a web page (i.e., users). For example, a user visiting a web page may upload an image with accompanying text and send a request via an application that the image and text be combined into a content item that is made visible to other users visiting the web page. In other cases, content and/or format of content items displayed on a web page are determined by an organization (e.g., the organization that owns the web page or an associated organization). Different users may be shown different content items when visiting a web page. Organizations may determine and/or may utilize software that determines which content items to show to a particular user. The use of the Internet has allowed targeted content delivery in a specific and instantaneous manner that is not possible with physical content delivery systems.

The Internet has also provided a variety of new opportunities for users to interact and engage with organizations. These include creating an online account on an organization's website, “following” an organization, and many others, some of which are discussed in further detail herein. In many cases, organizations seek to promote particular types of interactions with users, and the desired types of interactions may change from time to time. However, currently available systems fail to provide content delivery systems that effectively promote the different types of interactions desired by organizations. Moreover, such systems typically use identical format and content for content items from different organizations, creating redundancy and a poor user experience. It is beneficial to display particular content items from an organization to a particular user that both satisfy the purposes of the organization and maintain or improve the particular user's experience.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system 100 for distributing content items to one or more end-users, in an embodiment;

FIG. 2 is an illustration of an exemplary content item including multiple elements, in an embodiment;

FIG. 3 is a block diagram that depicts a system 300 for selectively rendering content items to one or more computing devices, in an embodiment;

FIG. 4 is a flow diagram that depicts a process 400 for rendering content items, in an embodiment; and

FIG. 5 is a block diagram that illustrates a computer system 500 upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for rendering content items to be displayed on a screen of a computing device. Format and content of content items are based on stated objectives from the entity, such as an organization, providing the content items. There may be many objectives for the entity to choose from, each designed to promote a particular user interaction or set of user interactions. Because of the variety of objectives, there is also greater variety in the look of content items, creating a more engaging user experience.

In one approach, a content item is identified based on an entity profile of the entity associated with a content request. An objective of a content delivery campaign is determined based on the content item, and at least a portion of the content and/or format of the content item is determined based on the objective. Thus, different objectives of different content delivery campaigns result in rendering respective content items differently.

### Content Delivery System Overview

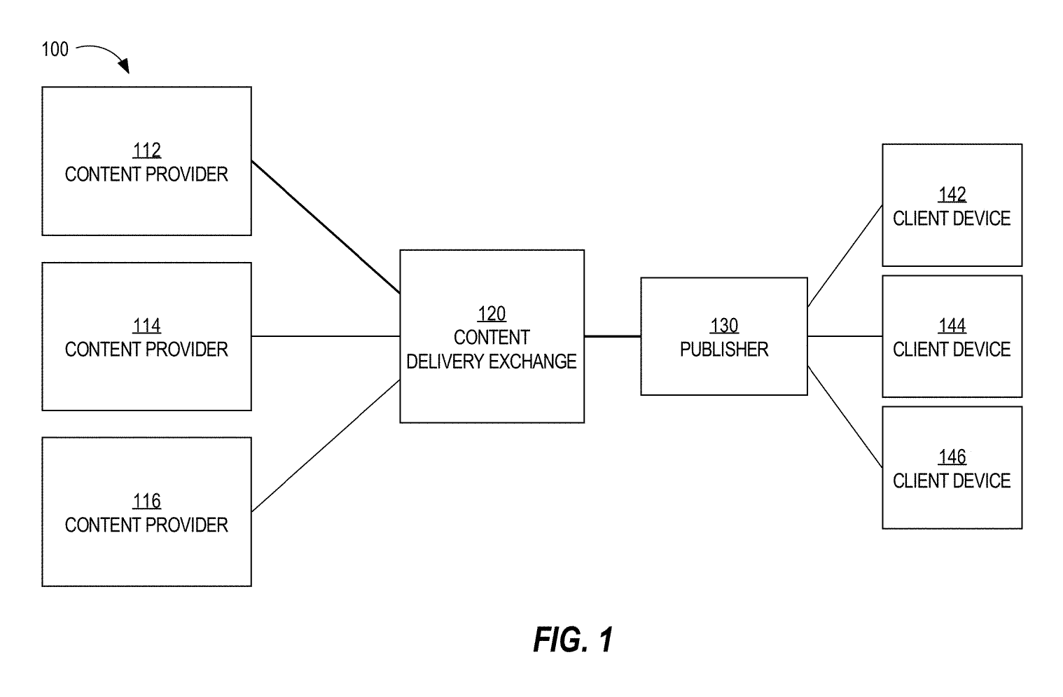

FIG. 1 is a block diagram that depicts a system 100 for distributing content items to one or more end-users, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, through publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

Content delivery exchange 120 and publisher 130 may be owned and operated by the same entity or party. Alternatively, content delivery exchange 120 and publisher 130 are owned and operated by different entities or parties.

Examples of client devices 142-146 include desktop computers, laptop computers, tablet computers, wearable devices, video game consoles, and smartphones.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device. For simplicity, the combination of images, videos, text samples, graphics, virtual reality features, and links in a content item may be referred to as the “content” of the content item and the individual images, videos, etc. in the content item may be referred to as “elements” of the content item.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user. As discussed below, content delivery campaigns may also have associated objectives.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, geographic information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Instead of one set of targeting criteria, the same content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different compensation schemes. For example, one content delivery campaign may compensate content delivery exchange 120 for each presentation of a content item from the content delivery campaign (referred to herein as cost per impression or CPM). Another content delivery campaign may compensate content delivery exchange 120 for each time a user interacts with a content item from the content delivery campaign, such as selecting or clicking on the content item (referred to herein as cost per click or CPC). Another content delivery campaign may compensate content delivery exchange 120 for each time a user performs a particular action, such as purchasing a product or service, downloading a software application, or filling out a form (referred to herein as cost per action or CPA). Content delivery exchange 120 may manage only campaigns that are of the same type of compensation scheme or may manage campaigns that are of any combination of the three types of compensation scheme.

### Tracking User Interaction

Content delivery exchange 120 tracks one or more types of user interaction across client devices 142-146. For example, content delivery exchange 120 determines whether a content item that exchange 120 delivers is displayed by a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of user selection, a time of the user selection, a particular publisher or source (e.g., onsite v. offsite), a particular client device that displayed the specific content item, and/or a user identifier of a user that operates the particular client device.

### Content and Format of Content Items

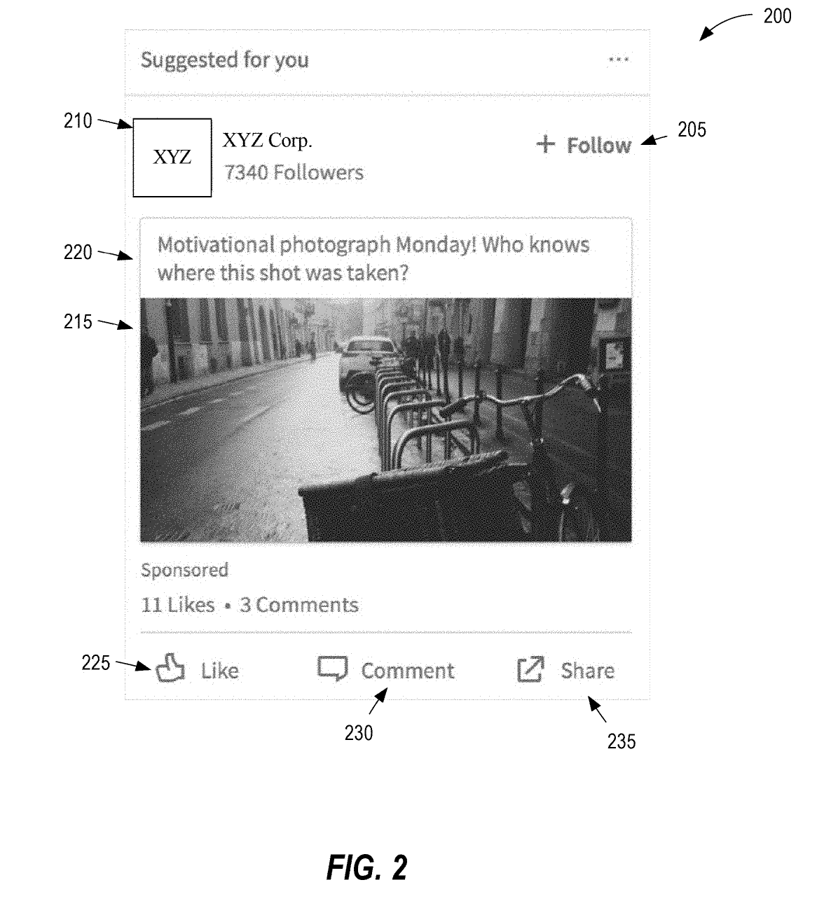

FIG. 2 is an illustration of an exemplary content item 200 including multiple elements. The elements in FIG. 2 include a “follow” button 205, organization identifier 210, image 215, text 220, a “like” button 225, a “comment” button 230, and a “share” button 235. One or more of these elements may also include links. For example, when a user selects the image 215, a request is sent over a network to a particular destination, such as a page in the organization's website. As another example, when a user selects the follow button 205, a request may be sent over a network to add the user to a list of “followers” of the organization. Exemplary organizations can include companies, partnerships, charities, government agencies/entities, non-governmental organizations, non-profit or for-profit groups, clubs, societies, or associations, etc. When a user selects the like button 225, a request may be sent over a network to increment a number of “likes” of the content item 200 and/or add the user to a list of users who have “liked” the content item 200. The like button 225, comment button 230, and share button 235 may collectively be referred to as “social engagement” elements. Another example of an element of a content item may include a “register” element, which, when selected by a user, allows the user to register (i.e., sign up) for a service provided by an organization.

A content item of a content delivery campaign may be static in that the content item may not change depending on the user that is to view the content item or the context of the page in which the content item is to appear. Alternatively, a content item may be dynamic such that the content item contains elements that are different depending on the user viewing the content item and/or the context of the page in which the content item appears. For example, a content item may include a name of a user that is to view the content item, a name of a university that that user attended, and/or a name of a company that is mentioned in an article that that user is viewing.

A “dynamic” content item of one type may be different than a dynamic content item of another type. For example, one dynamic content item may include a first and last name of a user while another dynamic content item may include only a first name, while other dynamic content item does not include a name of any user.

### Campaign Objectives

Content delivery campaigns may have associated objectives. Objectives are at least partially determinative of the content and/or format of content items that are associated with content delivery campaigns. A content provider that initiated a particular content delivery campaign may select the objective that is associated with the particular content delivery campaign. Each objective may be designed to drive one or more particular type of user interaction. Thus, a content provider may select an objective for a content delivery campaign based on the type of interaction the content provider seeks to establish with users.

One example of a campaign objective is acquiring followers of a particular organization. As discussed above, a follow is an element of a content item that, when selected by a user, associates the user with the organization. Such associated users may be referred to as followers of the organization. By electing to follow an organization, a user may demonstrate a willingness to engage with, learn more about, or otherwise be involved with an organization. Because some content items may be provided by or otherwise associated with a particular organization, tracking a user's follows may provide information as to which content items the user would like to see as well as which content items would be most likely to elicit a response from the user. A user who has chosen to follow an organization may also be more amenable to receive an above-average number of content items from the organization. Thus, more content items from the organization may be displayed to the user.

Other exemplary campaign objectives may include, without limitation, direct response, lead generation, online social engagement, registration, and generating visits of a web page of an organization. In a direct response campaign, an organization may seek to generate an immediate response from users. For example, a content item associated with a direct response campaign may include text and a hyperlink indicating that viewers should visit a company's website to claim a limited-time offer. In an online social engagement campaign, an organization may seek to generate engagement from users through use of social engagement elements such as like, comment, and share buttons. These elements may be associated with the organization but are distributed by a different organization, such as a social media company displaying the content item on their website. In a lead generation campaign, an organization may seek to initiate consumer interest or inquiry into products or services offered by the organization. For example, a lead generation campaign may involve prompting potential customers to provide an e-mail address to be contacted by a representative of the organization to learn more about a product offered by the organization.

As mentioned above, campaign objectives may be at least partially determinative of the content in a content item. In a follow campaign, an organization may seek to generate followers of the organization. Thus, a follow button may be included and prominently situated in a content item for a follow campaign. The follow button may be accompanied, for example, by text indicating incentives available to followers of the organization. The follow button and/or accompanying text may be determined by the content delivery exchange instead of the content provider of the follow campaign. As another example, in an online social engagement campaign, social engagement elements may be included and may be prominently situated so as to be easily noticed by a user.

Campaign objectives may also influence the format of content items. That is, the elements of content items may be organized differently depending on the objective. These differences may have functional purposes by situating certain elements in more or less visible and/or accessible portions of the content item. Formatting differences may also create greater variety in content items, which may provide a more pleasing and engaging user experience. Each campaign objective may be associated with particular content and/or format. The particular content and/or format of a particular objective may be uniform for all or at least multiple content items associated with the particular objective, even for content items from different content providers.

A user may select an objective for an existing campaign or during a creation process of a new campaign. For example, a user (e.g., a representative of the corresponding content provider or a representative of the content delivery exchange) may access a user interface to create a campaign. The user interface may provide an option for selecting an objective for the campaign. In an embodiment, the user interface may include a checkbox that, when selected, assigns a particular objective to the campaign. For new campaigns, the checkbox may be selected by default. For existing campaigns, the checkbox may be unselected by default.

Campaign objectives may also have associated compensation schemes. For example, in a campaign with an objective of acquiring followers, the campaign may compensate content delivery exchange 120 for each time a user selects the follow button. If the campaign has a different objective, even if a follow button is included in a content item associated with the campaign, there may be no compensation if users select the follow button. Alternatively, the follow button may not be included in such a campaign.

### Content Rendering System Overview

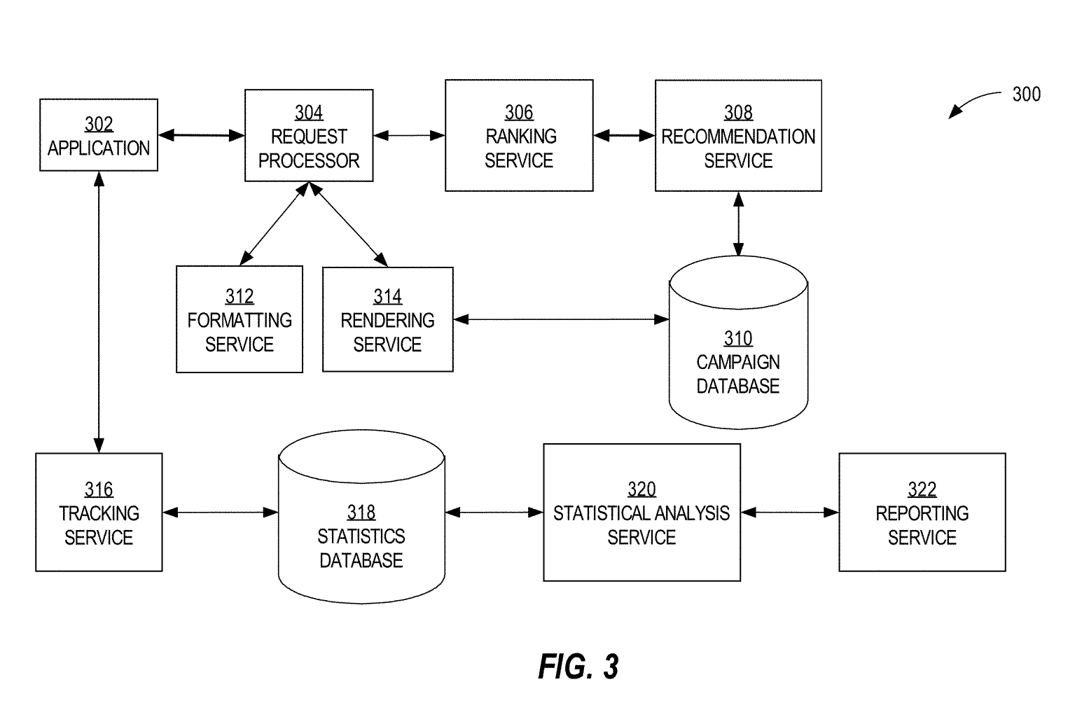

FIG. 3 is a block diagram that depicts a system 300 for selectively rendering content items to one or more computing devices, in an embodiment. System 300 includes an application 302, request processor 304, ranking service 306, recommendation service 308, campaign database 310, formatting service 312, rendering service 314, tracking service 316, statistic database 318, statistical analysis service 320, and reporting service 322. For illustrative purposes, the system 300 is illustrated as being composed of several distinct blocks, however individual blocks in the system 300 may be combined and/or split to form fewer or more blocks. In an embodiment, all of the blocks of system 300, other than application 302, are included in content delivery exchange 120.

The application 302 may be a program run by the one or more client devices 142-146 and sends requests to the request processor 304 for content items. The request processor 304 may be hosted on one or more computing devices, such as in a data center that comprises storage devices and computing devices hosting different services. Although rendering service 314 and tracking service 316 are depicted as being communicatively connected to databases 310 and 318, respectively, additionally or alternatively, request processor 304 (and/or other services not depicted) may be communicatively coupled to databases 310 and 318, such that request processor 304 may request data from, and store data to, databases 310 and 318.

The request sent to the request processor 304 may include a user (i.e., member) identifier, which identifies a registered member or user of a social network service. A user identifier is optional and specifies which user or member is to view the to-be-rendered content item(s). In return, the request processor 304 provides a tracking URL and various metadata to the application 302, including elements of the content item. Using the tracking URL and metadata, the application 302 constructs URLs having an action type and organizes the various elements of the content item for display. For example, the elements may be organized to provide a consistent look with other content items.

In response to a request from the application 302, the request processor 304 sends a request to the ranking service 306 for one or more content items. The ranking service 306 in return provides an identifier (e.g., a URN (or uniform resource number)) for a selected content item to the request processor 304, which the request processor 304 parses. The request processor 304 may also send requests to the rendering service 314 and the formatting service 312 to retrieve additional information. The rendering service 314 may provide, in return, information regarding which elements to include with a content item. For example, the rendering service 314 may provide information as to whether the content provider has selected to include a follow button, like button, or any other elements in content items. The formatting service 312 may provide formatting information for the content item. The request processor 304 may apply logic to the received information to generate a rendered content item.

In an embodiment, alternatively to sending a request to the ranking service 306, the request processor 304 may send the request directly to the recommendation service 308 for one or more content items.

In response to the request from the request processor 304, the ranking service 306 sends a request to the recommendation service 308. The ranking service 306 then receives a set of content items from the recommendation service 308 and evaluates each item based on one or more of relevancy to the user, bit amount, creation date, and/or applicability to the platform to be used to display the content item. The ranking service 306 selects one or more content items from the set and sends it to the request processor 304.

The recommendation service 308 receives the request from the ranking service 306 and/or request processor 304. The request may include, without limitation, the user identifier and a request for user profile information, geographical information of the client device, and/or fetch frequency information. The recommendation service 308 matches targeting criteria of available content delivery campaigns to the targeted criteria associated with the request, which may include one or more of geography, date, time, industry, job title, seniority, skill, endorsement, etc.

The recommendation service 308 retrieves campaign information for one or more campaigns from campaign database 310 and matches request criteria with targeting criteria of each campaign. A campaign may be associated with multiple content items, all of which may be displayed or only a subset of which may be displayed. For each campaign stored in the campaign database 310, the campaign database 310 also stores information for an objective associated with the campaign.

The campaign database 310 may store multiple versions of a content item. For example, after a content provider changes an objective of an existing campaign, the application 302 may send a request for a new content item. After the new content item is created, the campaign database 310 may store the new version and the previous version of the content item, each version representing a different objective.

The recommendation service 308 and/or ranking service 306 may make determinations based on previous interactions between the user and a content provider. These determinations may involve determining a level of interaction between the user and the content provider. For example, if a visitor of a web page has previously selected a follow button of a content item associated with a particular content provider, then the recommendation service 308 and/or ranking service 306 may be more likely to select a content item associated with the particular content provider. In this way, the visitor may be more likely to see content items from content providers that the visitor follows.

As mentioned above, the request processor 304 may send requests to the rendering service 314 and the formatting service 312. Each request includes an identifier (e.g., URN) of the content item selected by the ranking service 306. The rendering service 314 determines which elements to include with the content item. For example, if the associated content provider has selected as an objective for a campaign to acquire followers of a particular organization, then the rendering service 314 may determine that a follow button should be included with the content item. The name and logo of the organization may also be included in the content item. The rendering service 314 may reference the campaign database 310 to access the relevant information if the information is not available from a response from ranking service 306.

The formatting service 312 determines where each element is situated in the content item. This determination may also be based on a selected objective. For example, if a user has selected a social engagement objective, then a share button may be situated at the top of a content item, while if the content provider has selected a follower acquisition objective, then the share button may still be included but may be moved to a bottom portion of the content item.

Content items may have associated types. The format of a content item is at least partially dictated by the content item's type. Example formatting parameters include size of the content item (e.g., x and y dimensions), font size, font color, background color, location of any graphic within the content item, location of any text within the content item, and location of any image (e.g., a profile picture) within the content item. As a specific example, a content item of a first type may include a last name followed by a first name while a content item of a second type may include a last name with no first name. Thus, different types of content items may contain different types of data or amounts of data. If two types of content items contain the same amount and type of data, then the way the data within each content item is formatted or arranged is different.

The formatting service 312 and/or rendering service 314 may determine the type of content item in one of multiple ways. For example, the type of a content item may be determined based on (a) type data contained within the campaign database 310 that the rendering service 314 may have accessed by using one or more content item identifiers, (b) the type of data items contained within the content item data, or (c) which front-end service (e.g., request processor 304) called the rendering service 314. The identity of the calling service may be indicated in the initial request.

Formatted data may be populated into a viewable template using HTML, JSON, or other data format (e.g., as indicated in the initial request, if so). Different front-end services may require different data formats. For example, request processor 304 may expect data formatted (or organized) in JSON while another service may expect data formatted (or organized) in HTML.

In an embodiment, the rendering service 314 is implemented using three different components: a data gathering component, a rendering component, and a view component. This is similar to the software architectural pattern referred to as MVC (or model-view-controller), which is used for implementing user interfaces. MVC divides a given software application into three interconnected parts, so as to separate internal representations of information from the ways that information is presented to or accepted from the user. The central component of MVC, the model, captures behavior of the application in terms of its problem domain, independent of the user interface. The model directly manages the data, logic, and rules of the application. The view can be any output representation of information, such as a chart or a diagram. Multiple views of the same information are possible, such as a bar chart for management and a tabular view for accountants. The controller accepts input and converts the input into commands for the model or view.

In addition to dividing the application into three different components, the MVC design defines the interactions between them. A model stores data that is retrieved according to commands from the controller and displayed in the view. The view generates new output to the user based on changes in the model. The controller sends commands to the model to update the model's state (e.g. editing a document). The controller can also send commands to the view to change the view's presentation of the model (e.g., by scrolling through a document).

The tracking service 316 monitors user activity with respect to content items. For example, if a user visiting a web page that includes a content item selects the content item, then the tracking service 316 registers the event and sends the information about the event to a statistics database 318 for storage. The tracking service 316 may track not only when a content item is selected, but which element of the content item is selected. This information is also relayed to the statistics database 318. Additional information, such as information that identifies the user and/or organization that owns the content item, the campaign to which the content item belongs, and the objective of the content item may be also tracked and associated with the stored information. The information stored at the statistics database 318 can be used in a variety of ways, including reducing a resource budget associated with a content provider for each time a user selects a particular element (e.g., the follow button) of a content item provided by the content provider.

The statistical analysis service 320 may perform various functions on the data stored in the statistics database 318. These functions may generate data that is sent to a reporting service 322. The reporting service provides the data to a user (e.g., via a user interface) running the services. In this way, the user (such as an administrator of content delivery exchange 120) can evaluate the tracked statistics.

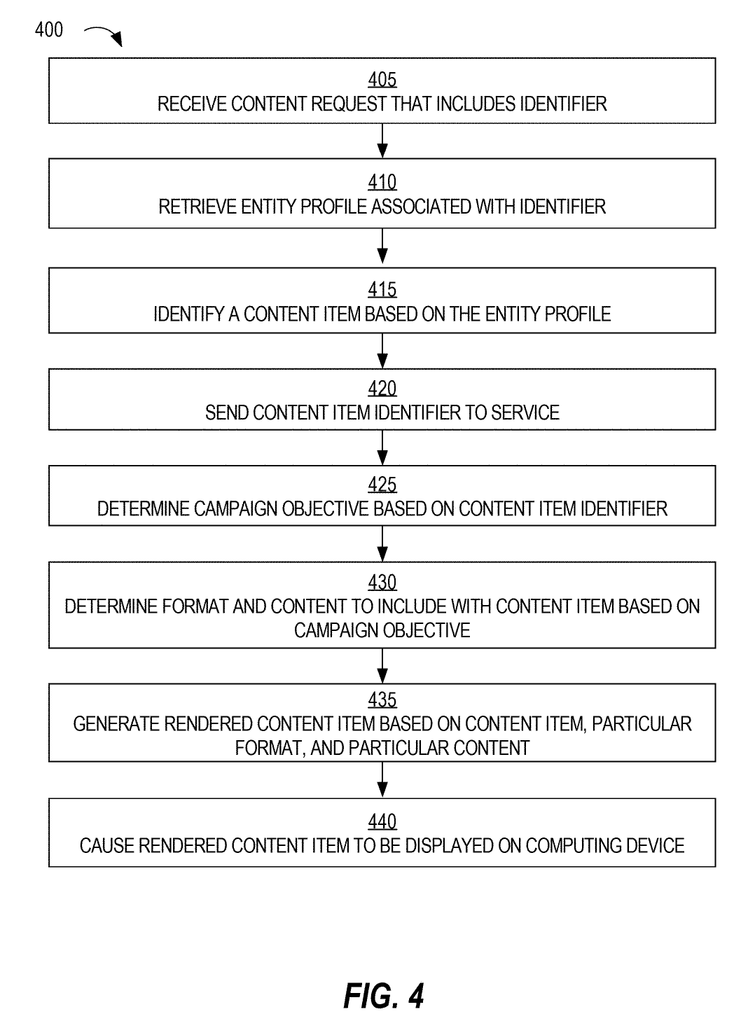

FIG. 4 is a flow diagram that depicts a process 400 for rendering content items, in an embodiment.

At block 405, a first service (e.g., recommendation service 308) receives a first request for one or more content items. The request may originate from a client device or other computing device over a network. Embodiments are not limited to any type of network connection. The request may not specify any content items. Instead, the first service is responsible for identifying one or more content items, based, for example, on an identifier contained within the request. The identifier may be a client device identifier, a user identifier, and/or attribute data that indicates one or more attributes or characteristics of a client device (upon which the content item(s) will be displayed) and/or user of the client device.

At block 410, the first service receives an entity profile associated with the identifier. For example, if the identifier comprises an entity (or user) identifier, the recommendation service 308 may retrieve, from the campaign database 310, based on the entity identifier, a profile of a particular entity identified by the entity identifier. Examples of entities include a user, an organization (e.g., a company or academic institution), or a group (of users and/or organizations). An entity profile can include a variety of information about the entity, including demographic information, geographic information, job title, employment status, academic degrees earned, academic institutions attended, former employers, current employer, number of connections in a social network, number and type of skills, number of endorsements, and stated interests.

For each campaign of multiple content delivery campaigns stored in the campaign database 310, targeting criteria associated with the campaign is compared to data within the profile of the particular entity. If the targeting criteria of a campaign are satisfied (at least in the part), then the campaign is identified as a candidate campaign. Once a set of campaigns is identified in this manner, the first service may further filter the set of campaigns to remove campaigns based on one or more other criteria, such as resource availability associated with each campaign, frequency caps associated with each campaign, and projected/predicted revenue of each campaign.

Regardless of how one or more content delivery campaigns are identified, the first service may send identification data that identifies the one or more campaigns or one or more content items that are associated with the one or more campaigns. At step 415, a content item may be identified based on the entity profile. For example, the recommendation service 308 may send identification data to the ranking service 306 and the ranking service 306 may select a content item based on ranking the various content items received from the recommendation service 308 for compatibility with the entity profile.

At step 420, the identified content item may be sent to a particular service along with a content item identifier. The content item identifier may be, for example, a URN. In an embodiment, a campaign and/or objective identifier may be sent with the content item identifier. The particular service may comprise one or more of the request processor 304, rendering service 314, and formatting service 312.

At step 425, a campaign objective may be determined based on the content item identifier. For example, the content item identified by the content item identifier may be associated with a campaign and the campaign may have an associated objective.

At step 430, particular format and content to include with the content item may be determined based on the campaign objective. For example, the request processor 304 may send requests to the rendering service 314 and formatting service 312. In an embodiment, the request processor 304 does not send a request to the formatting service 312 until it has received a response from the rendering service 314. If, for example, the campaign objective is acquiring followers, then rendering service 314 may determine a follow button should be included in the content item and the formatting service 312 may determine that the follow button should be situated at the top of the content item in order to be more clearly visible.

The identifier may identify a content delivery campaign and rendering service 314 uses the identifier to retrieve data about a corresponding content delivery campaign from the campaign database 310. Each content delivery campaign is associated with at least one content item identifier, which rendering service 314 uses to retrieve data about a corresponding content item from a content item database. Either the campaign data or the content item data indicates a type of content item.

At step 435, a rendered content item may be generated based on the content item, particular format, and particular content. For example, the request processor 304 may receive the particular format and particular content and generate the rendered content item.

At step 440, the application 302 or other service causes the rendered content item to be displayed on a computing device upon which application 302 executes.

In an embodiment, content items may appear in a feed on a web page. The feed may be in the middle or any other portion of the web page and may include content items created by visitors of the web page (e.g., a homepage of a visitor) and/or by organizations. The feed may update periodically and/or when the web page receives a new content item (e.g., from application 302). The frequency at which content items from a particular organization are displayed to different visitors of the web page may be different and may be based on an identifier associated with a particular visitor and on one or more campaigns and/or campaign objective associated with the particular organization. For example, if a visitor is a follower of an organization, then content items from the organization may appear in the feed more frequently for the visitor than for visitors who are not followers of the organization. If the organization has more than one campaign, then content items from the organization may also appear in the feed more frequently (e.g., displaying a content item for each campaign) for the visitor than if the organization had only one campaign. Also, if the organization has a campaign with an associated campaign objective and/or campaigns with different associated campaign objectives, then content items from the organization may also appear in the feed more frequently for the visitor than if the organization has only campaigns that do not have associated campaign objectives or only campaigns with the same associated campaign objective. That is, because campaign objectives provide more variety in content and format of content items, content items with associated campaign objectives may be displayed more frequently because there is less risk of over-saturating the feed with similar-looking content items.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

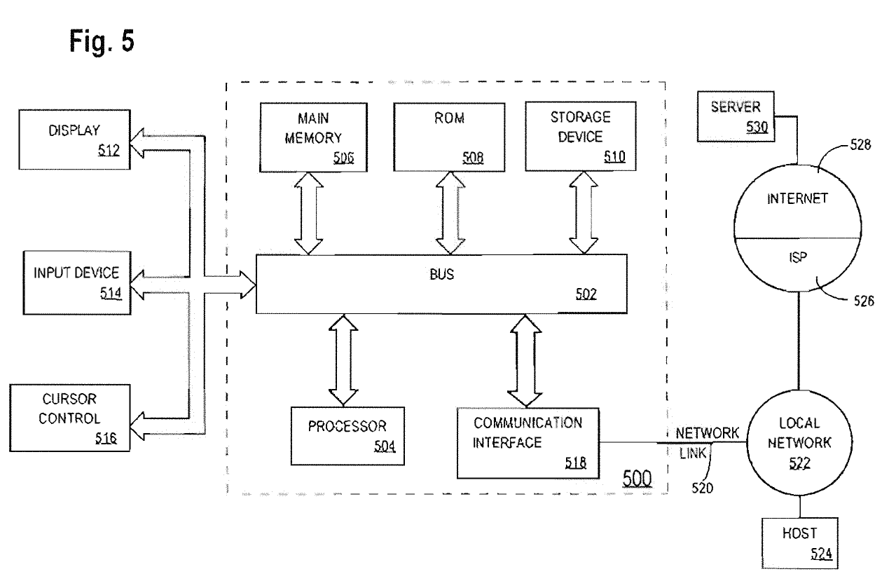

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A system comprising:
one or more processors;
one or more storage media storing instructions which, when executed by the one or more processors, cause:
receiving, over a network, a content request that includes an identifier;
in response to receiving the content request:
based on the identifier, retrieving an entity profile of an entity that is associated with the identifier;
based on the entity profile, identifying a content item;
determining, based on a content item identifier that identifies the content item, a particular campaign objective from among a plurality of campaign objectives;
determining, based on the particular campaign objective, a particular format for, or particular content to include with, the content item;
generating a rendered content item based on the content item and at least one of the particular format and the particular content; and
causing the rendered content item to be displayed on a screen of a computing device.

2. The system of claim 1, wherein the content item is associated with a first content delivery campaign, wherein the instructions, when executed by the one or more processors, further cause:
receiving, over the network, a second content request that includes a second identifier;
in response to receiving the second content request:
based on contents within the second content request, identifying a second content item that is associated with a second content delivery campaign that is different than the first content delivery campaign;
determining, based on a second content item identifier that identifies the second content item, the particular campaign objective from among the plurality of campaign objectives;
determining, based on the particular campaign objective, the particular format or the particular content to include with the second content item;
generating a second rendered content item based on the second content item and at least one of the particular format and the particular content; and
causing the second rendered content item to be displayed on a screen of a second computing device.

3. The system of claim 1, wherein the content item is a first content item, wherein the instructions, when executed by the one or more processors, further cause:
receiving, over the network, a second content request that includes a second identifier;
in response to receiving the second content request:
based on contents within the second content request, identifying a second content item that is different than the first content item;
determining, based on a second content item identifier that identifies the second content item, a second campaign objective from among the plurality of campaign objectives, wherein the second campaign objective is different than the particular campaign objective;
determining, based on the second campaign objective, a second format in which the second content item is to be displayed, wherein the second format is different than the particular format;
generating a second rendered content item based on the second content item and the second format; and
causing the second rendered content item to be displayed on a screen of a second computing device.

4. The system of claim 1, wherein the plurality of campaign objectives include two or more of following an organization, online social engagement with one or more content items that are associated with the organization and that are distributed by a party that is different than the organization, registering with the organization, or visiting a web page provided by the organization.

5. The system of claim 1, wherein the particular content is one of a plurality of user interface elements that comprises one or more of a register element, a follow element, a social engagement element, and a link element that refers to a particular web page of an organization that is associated with the content item.

6. The system of claim 1, wherein the particular format is at least one of a particular positioning, size, or color.

7. The system of claim 1, wherein the instructions, when executed by the one or more processors, further cause sending, to a particular service, the content item identifier that identifies the content item, wherein determining the particular campaign objective is performed by the particular service.

8. A method comprising:
receiving, over a network, a content request that includes an identifier;
in response to receiving the content request:
based on the identifier, retrieving an entity profile of an entity that is associated with the identifier;
based on the entity profile, identifying a content item;
determining, based on a content item identifier that identifies the content item, a particular campaign objective from among a plurality of campaign objectives;
determining, based on the particular campaign objective, a particular format for, or particular content to include with, the content item;
generating a rendered content item based on the content item and at least one of the particular format and the particular content; and
causing the rendered content item to be displayed on a screen of a computing device.

9. The method of claim 8, wherein the content item is associated with a first content delivery campaign, the method further comprising:
receiving, over the network, a second content request that includes a second identifier;
in response to receiving the second content request:
based on contents within the second content request, identifying a second content item that is associated with a second content delivery campaign that is different than the first content delivery campaign;
determining, based on a second content item identifier that identifies the second content item, the particular campaign objective from among the plurality of campaign objectives;
determining, based on the particular campaign objective, the particular format or the particular content to include with the second content item;
generating a second rendered content item based on the second content item and at least one of the particular format and the particular content; and
causing the second rendered content item to be displayed on a screen of a second computing device.

10. The method of claim 8, wherein the content item is a first content item, the method further comprising:
receiving, over the network, a second content request that includes a second identifier;
in response to receiving the second content request:
based on contents within the second content request, identifying a second content item that is different than the first content item;
determining, based on a second content item identifier that identifies the second content item, a second campaign objective from among the plurality of campaign objectives, wherein the second campaign objective is different than the particular campaign objective;
determining, based on the second campaign objective, a second format in which the second content item is to be displayed, wherein the second format is different than the particular format;
generating a second rendered content item based on the second content item and the second format; and
causing the second rendered content item to be displayed on a screen of a second computing device.

11. The method of claim 8, wherein the plurality of campaign objectives include two or more of following an organization, online social engagement with one or more content items that are associated with the organization and that are distributed by a party that is different than the organization, registering with the organization, or visiting a web page provided by the organization.

12. The method of claim 8, wherein the particular content is one of a plurality of user interface elements that comprises one or more of a register element, a follow element, a social engagement element, and a link element that refers to a particular web page of an organization that is associated with the content item.

13. The method of claim 8, wherein the particular format is at least one of a particular positioning, size, or color.

14. The method of claim 8, further comprising sending, to a particular service, the content item identifier that identifies the content item, wherein determining the particular campaign objective is performed by the particular service.
